(19) United States
(12) Patent Application Publication
(10) Pub. No.: US 2023/0331408 A1
(43) Pub. Date: Oct. 19, 2023

(54) WEATHER-RESISTANT UNMANNED AERIAL VEHICLES, AND ASSOCIATED SYSTEMS AND METHODS

(71) Applicant: Aigen, Inc., Seattle, WA (US)

(72) Inventor: Richard Wurden, Seattle, WA (US)

(21) Appl. No.: 18/008,650

(22) PCT Filed: May 19, 2021
(86) PCT No.: PCT/US2021/033133

§ 371 Date: Dec. 6, 2022

Related U.S. Application Data
(60) Provisional application No. 63/027,253, filed on May 19, 2020.

(51) Int. Cl. B64U 10/25; B64U 30/10; B64U 50/13; B64U 50/31; B64C 39/10; B64C 39/02

(52) U.S. Cl. CPC B64U 10/25; B64U 30/10; B64U 50/13; B64U 50/31; B64C 39/10; B64C 39/024

(57) ABSTRACT

The present technology is directed to an unmanned aerial vehicle (UAV) a wing. The UAV can include first and second propellers extending from a front portion of the wing and positioned to provide thrust to the UAV. The UAV can include a first actuator carried by the wing, and a first leg operably coupled to the first actuator. The first leg can be configured to rotate in a first plane parallel to a plane bisecting the wing. In some embodiments, the UAV includes a second leg connected to a second actuator, the second leg configured to rotate in a plan parallel to the first plane.

### CROSS-REFERENCE TO RELATED APPLICATION

This application claims priority to U.S. provisional application No. 63/027,253, filed May 19, 2020 and entitled WEATHER RESISTANT VTOL ROBOTIC SYSTEM WITH BIOMIMICRY CAPABILITIES AND RELATED METHODS, the entire content of which is hereby incorporated by reference and made part of the present disclosure.

### TECHNICAL FIELD

The present technology is directed generally to unmanned aerial vehicles (UAVs) and associated systems and methods.

### BACKGROUND

UAVs can be and are often used for missions that other aircraft are incapable of performing. For example, the ability of many UAVs to land and take off from very small landing zones can allow UAVs to access areas the conventional aircraft are unable to access. However, many UAV designs suffer from an inability to fly, land, and/or takeoff during adverse weather (e.g., high winds). Additionally, many UAVs require fixed charging and/or refueling stations in order to perform long distance missions.

### BRIEF DESCRIPTION OF THE DRAWINGS

FIG. 1A is a front, right, top perspective view of a UAV configured in accordance with embodiments of the present technology.

FIG. 1B is a rear elevational view of the UAV of FIG. 1A.

FIG. 1C is a front elevational view of the UAV of FIG. 1A.

FIG. 1D is a left-side elevational view of the UAV of FIG. 1A.

FIG. 1E is a top plan view of the UAV of FIG. 1A.

FIG. 1F the bottom plan view of the UAV FIG. 1A.

FIG. 2A is a left-side elevational view of the UAV of FIG. 1A with front and rear legs in extended positions.

FIG. 2B is a cross-sectional view of the UAV of FIG. 1A, take along the cut-plane 2B-2B of FIG. 1F.

FIG. 2C is a cross-sectional view of the UAV of FIG. 1A, take along the cut-plane 2C-2C of FIG. 1F.

FIG. 2D is a rear, left, top perspective view of the internal components of the UAV of FIG. 1A.

FIGS. 3A-3G illustrate a method of launching a UAV in accordance with embodiments of the present technology.

FIGS. 4A-4H illustrate a method of landing a UAV in accordance with embodiments of the present technology.

FIG. 5A illustrates a cross-sectional view of the UAV of FIG. 1A, take along the cut-plane 2B-2B of FIG. 1F, wherein the UAV is an initial landed position.

FIG. 5B illustrates a cross-sectional view of the UAV of FIG. 1A, take along the cut-plane 2B-2B of FIG. 1F, wherein the legs of the UAV engage the ground.

FIG. 6 illustrates a cross-sectional view of the UAV of FIG. 1A, take along the cut-plane 2B-2B of FIG. 1F, wherein the legs of the UAV grasp a landing structure.

FIGS. 7A-7E illustrate a method of walking the UAV in accordance with embodiments of the present technology.

FIGS. 8A-8E illustrate another method of walking the UAV in accordance with embodiments of the present technology.

FIG. 9 illustrates a method of aligning solar panels on the UAV with the sun in accordance with embodiments of the present technology.

FIG. 10 illustrates a fleet of UAVs within a mission perimeter configured in accordance with embodiments of the present technology.

FIG. 11A illustrates a top plan view of a UAV configured in accordance with embodiments of the present technology.

FIG. 11B illustrates a side elevational view of the UAV of FIG. 11A.

FIGS. 12A-12D illustrate another method of launching a UAV in accordance with embodiments of the present technology.

### DETAILED DESCRIPTION

Embodiments of the technology disclosed herein are directed generally to unmanned aerial vehicles (UAVs). The UAVs can include various features such as, for example, single wing bodies, multifunction legs, solar charging panels, multifunction stabilizers, cameras, and/or other features. The UAVs can be configured for long distance missions that may require landing and/or charging without use of fixed charging stations or other fixed infrastructure. In some embodiments, the UAVs are configured to withstand high winds by, for example releasably attaching to the ground or other landing structures. The UAVs can be operated by users (e.g., remote pilots) and/or automatically (e.g., the automatic performance of an assigned mission).

Several embodiments of the present technology are directed to UAVs having a main body comprising a wing. The UAVs can include one or more propellers (e.g., two propellers) extending from a front of the main body. The propellers can be configured to control thrust and yaw. In some embodiments, the UAV includes solar cells positioned over a majority of the top surface of the wing. The UAV can include one or more legs configured to assist with takeoff, landing, and/or securing the UAV to a feature of a landing site.

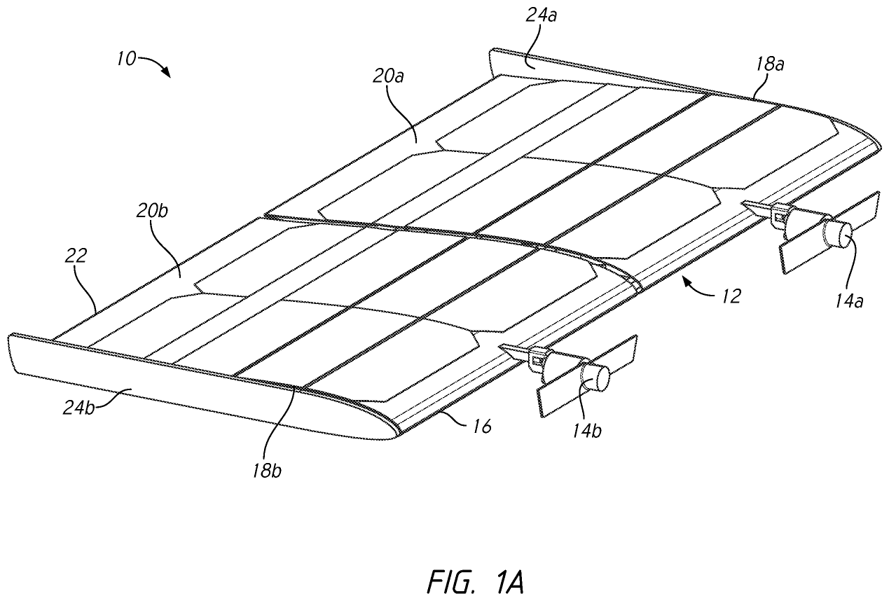

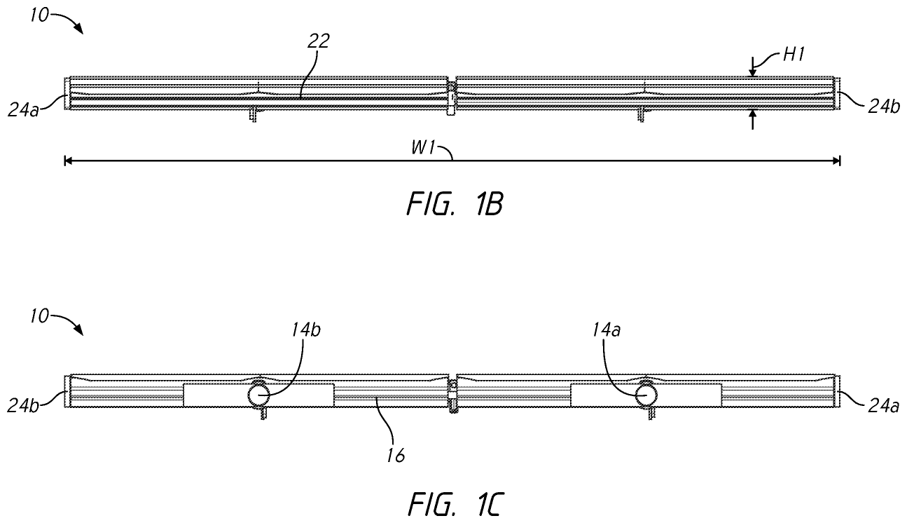

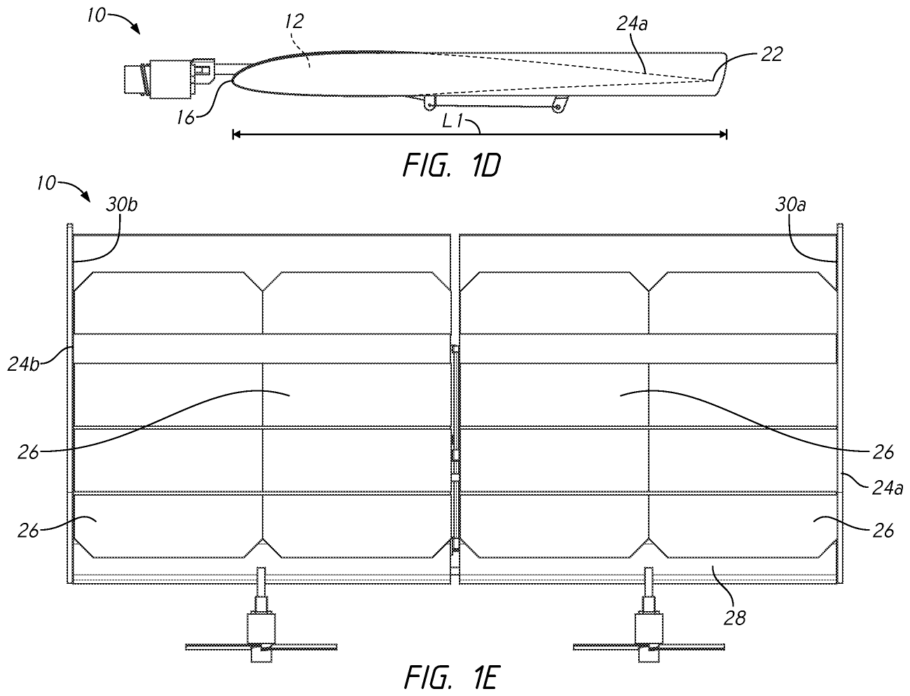

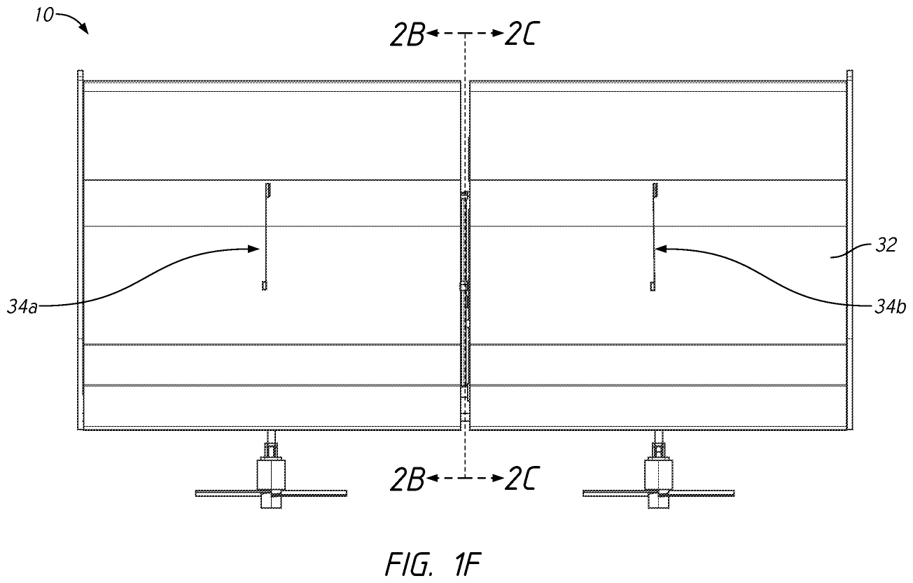

For clarity, well-known features generally associated with UAVs that may unnecessarily obscure some significant aspects of the presently disclosed technology are not set forth in the following description. Moreover, although the following disclosure sets forth several embodiments of the present technology, several other embodiments can have different configurations and/or different components than those described in this section. As such, the present technology may have other embodiments with additional elements, and/or without several of the elements described below with reference to FIGS. 1A-12D.

Several of the features are described below with reference to particular corresponding Figures. Any of the features described herein may be combined in suitable manners with any of the other features described herein, without deviating from the scope of the present technology.

One drawback with current UAV technology is that UAVs often require fixed charging stations or other infrastructure in order to perform long distance missions that extend beyond the range of a single charge. This drawback can be particularly challenging in remote or otherwise undeveloped areas. For example, mountainous regions, farmland, desert, and other undeveloped or underdeveloped regions often lack sufficient roadways, utilities, and other infrastructure needed to establish fixed charging stations. In some cases, UAV missions may traverse hostile or otherwise inhospitable regions wherein charging stations would be unavailable.

Another drawback of current UAV technology is inefficient charging away from charging stations. For example, UAVs often have small and/or obstructed solar panels, if they have solar panels at all. Inefficient charging can reduce the range of the UAVs in flight and/or increase the time necessary to charge the UAVs when landed.

Yet another drawback of current UAV technology is the inability of most UAVs to withstand high winds, whether in flight or on the ground. It can be difficult to land many UAVs in high winds, which can lead to damage or loss of the UAVs. It can also be difficult to avoid damage to UAVs on the ground during high winds. This can be particularly challenging for UAVs that require vertical takeoff and landing, as UAVs are vulnerable to tipping while in a vertical landing or takeoff position.

FIG. 1A illustrates a perspective view of a UAV 10 configured in accordance with embodiments of the present technology. The UAV 10 includes a main body 12. The main body 12 of the UAV 10 can be, for example, a single wing or combination of wings. The UAV 10 can include one or more propellers 14a, 14b or other thrust devices configured to propel the UAV 10 during flight and on the ground. The propellers 14a, 14b can extend from a front portion 16 of the main body 12. In the illustrated example, the UAV 10 includes two propellers 14a, 14b spaced from each other between the lateral ends 18a, 18b of the main body 12. The propellers 14a, 14b can be configured to control yaw of the UAV 10 both in flight and on the ground. For example, differential thrusts between the two propellers 14a, 14b can cause the UAV 10 to turn about the yaw axis.

The UAV 10 can include one or more elevons 20a, 20b at a rear portion 22 of the main body 12. In the illustrated embodiment, the UAV 10 includes two elevons. The two elevons 20a, 20b can span all or most of the width of the main body 12. For example, the first elevon 20a can span one half of the width of the main body 12 and the second elevon 20b can span the remaining half of the width of the main body 12. The elevons 20a, 20b can be configured to tilt or otherwise actuate up and down independent of each other. Accordingly, the elevons 20a, 20b can be used to control the pitch and roll of the UAV 10 during flight.

In some embodiments, the UAV 10 includes a first stabilizer 24a on a first lateral end 18a of the main body 12 and a second stabilizer 24b on a second lateral end 18b of the main body 12. The stabilizers 24a, 24b can be configured to reduce side slippage of air past the lateral ends 18a, 18b of the main body 12 during flight. As explained below, the stabilizers 24a, 24b can also function as skis during ground maneuvering.

In some embodiments, the UAV 10 includes a fuselage (not shown) connected to the main body 12. For example, a fuselage can be connected to the front portion 16 of the main body 12 and extend forward therefrom. In some embodiments, the fuselage can be connected to the top surface of the main body 12. The fuselage can be used to carry electronics, cameras, and/or other components.

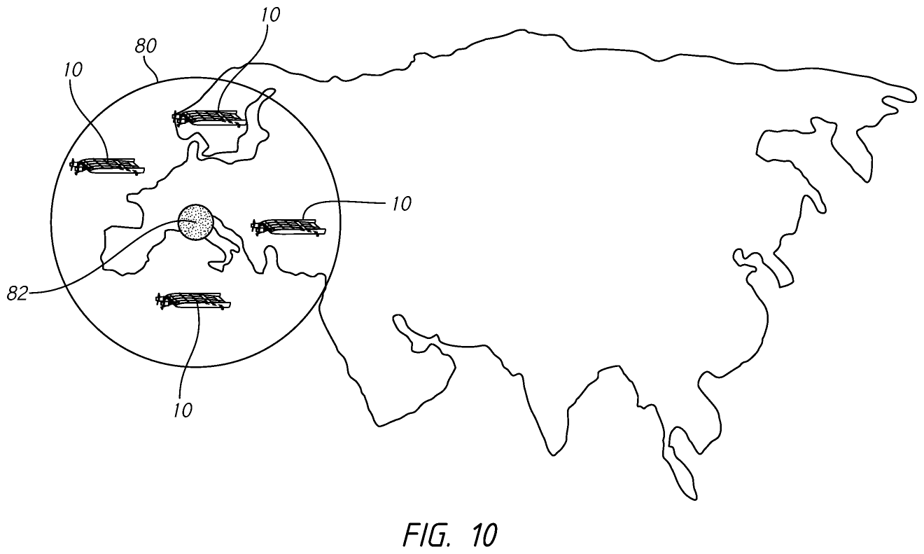

FIGS. 1B and 10 illustrate rear and front elevational views of the UAV 10, respectively. As illustrated in FIG. 1B, the UAV 10 can have a very high aspect ratio (e.g., the ratio between the width W1 and height H1 of the UAV 10). In some embodiments, the aspect ratio is between 10:1 and 30:1, between 15:1 and 25:1, and/or between 18:1 and 22:1. In some embodiments, the aspect ratio is approximately 20:1. The UAV 10 can be constructed without vertical stabilizers, rudders, or other aerodynamic structures extending upward or downward beyond the frontal profile of the UAV 10. The high aspect ratio of the UAV 10 can reduce overall drag on the UAV 10 in flight.

FIG. 1D illustrates a side elevational; view of the UAV 10. The profile of the main body 12 is illustrated in phantom, as it is positioned behind the stabilizer 24a. As shown in this view, the profile of the stabilizer 24a can match or approximately match the profile (e.g., the shape when viewed from the side) of the main body 12 along a portion of the length L1 of the main body 12. For example, the shape of the stabilizer 24a can match the shape of the main body 12 along a front portion of the stabilizer 24a. In some embodiments, the shape of the stabilizer 24a matches the shape of the main body 12 along at least 10%, at least 15%, at least 20%, at least 25%, at least 30% and/or at least 35% of the length L1 of the stabilizer 24a. The stabilizer 24a can extend above and/or below the rear portion 22 of the main body 12. In some embodiments, the stabilizer 24a extends beyond the rear portion 22 of the main body 12 in a direction opposite the front portion 16 of the main body 12. Extending the stabilizer 24a above, below, and/or beyond the rear portion 22 of the main body 12 (e.g., beyond the elevons 20a, 20b) can protect the rear portion 22 of the main body 12 during takeoff, landing, and when the UAV 10 is on the ground.

FIG. 1E illustrates a top plan view of the UAV 10. As best seen in this figure, the UAV 10 can include one or more solar panels 26 on an upper surface 28 of the main body 12. In some embodiments, the solar panels 26 cover most of the upper surface 28 of the main body 12 and the elevons 20a, 20b. For example, the solar panels 26 can cover between 50%-95%, between 60%-90%, between 70%-80%, and/or between 75%-85% of the upper surfaces 28 of the main body 12 and elevons 20a, 20b. Using solar panels 26 that cover a large portion of the upper surface 28 of the main body 12 of UAV 10 can increase the range of the UAV 10 in flight and can reduce the amount of time necessary to charge the UAV 10 when landed. In some embodiments, the stabilizers 24a, 24b include one or more grooves or other cutouts (e.g., on inner surfaces 30a, 30b of the stabilizers 24a, 24b that face the main body 12) configured to allow more sunlight to access the solar panels 26. The solar panels 26 can be configured to charge the UAV 10 both in flight and on the ground.

FIG. 1F illustrates a bottom plan view of the UAV 10. As illustrated, the lower surface 32 of the main body 12 can be generally free from rudders, fins, or other structures that would increase drag on the UAV 10). In some embodiments, portions of elevon control systems 34a, 34b, described in more detail below, may extend beyond the lower surface 32 of the main body 12.

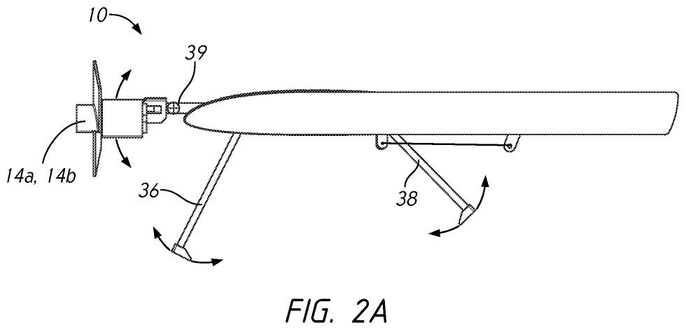

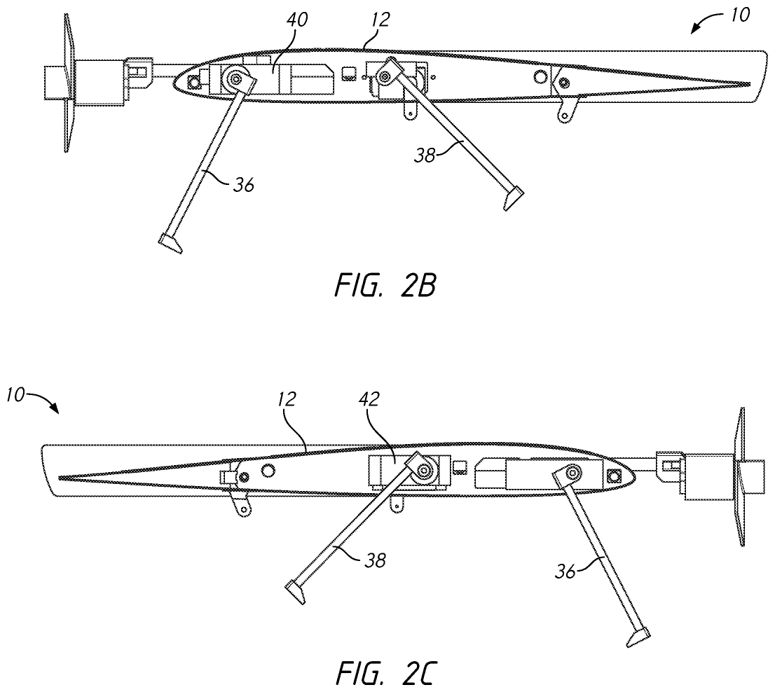

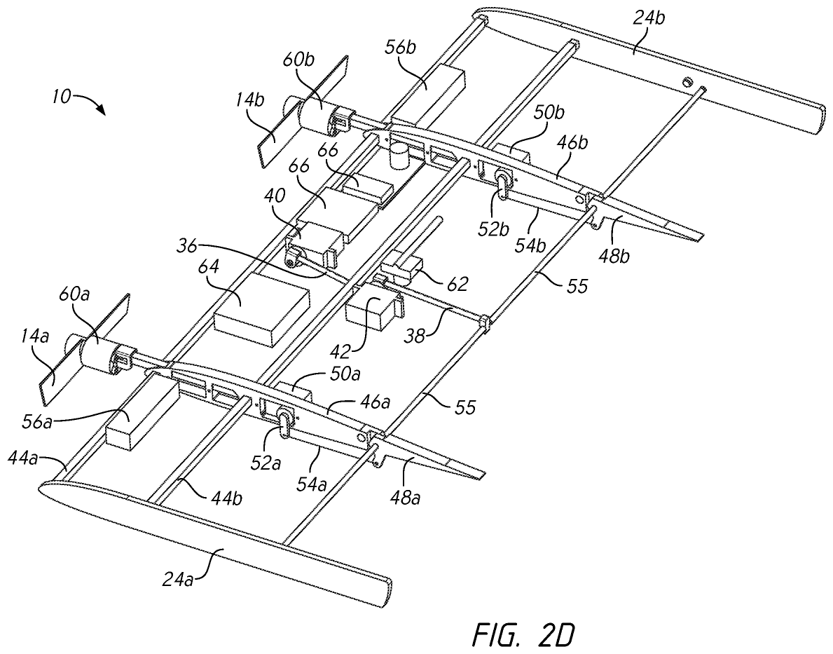

FIG. 2A illustrates a side elevational view of the UAV 10 when legs of the UAV 10 are in extended positions. The UAV 10 can include a front (or first) leg 36. The front leg 36 can rotate or articulate between an extended position (FIG. 2A) wherein a free end of the front leg 36 is positioned below the main body 12 and/or in front of the front portion 16 of the main body 12, and a retracted position (e.g., a stowed position, shown in FIGS. 1A-1F) wherein all or most of the front leg 36 is positioned within the main body 12. In some embodiments, the front leg 36 rotates within a first plane parallel to a plane that bisects the main body through the front and rear portions of the main body 12. The front leg 36 can have a length between 10%-70%, between 20%-60%, between 25%-50%, and/or between 30%-40% the length of the stabilizers 24a, 24b. In some embodiments, the length of the front leg 36 is approximately 33% of the length L1 of the stabilizers 24a, 24b. In some embodiments, the length of the front leg 36 is approximately 50% of length L1 the stabilizers 24a, 24b.

In some embodiments, the UAV 10 includes a rear (or second) leg 38. The rear leg 38 can rotate or articulate between an extended position (FIG. 2A) wherein a free end of the rear leg 38 is positioned below the main body 12 and behind the front leg 36, and a retracted position (e.g., stowed position, shown in FIGS. 1A-1F) wherein all or most of the rear leg 38 is positioned within the main body 12. In some embodiments, the rear leg 38 rotates within a second plane parallel to the first plane. In some embodiments, the second plane is coplanar with the first plane.

The propellers 14a, 14b can, in some embodiments, be coupled to the main body 12 via one or more hinges 39 or other structures that allow the propellers 14a, 14b to tilt upward and/or downward with respect to the main body 12. Tilting the propellers 14a, 14b can assist with controlling pitch and/or roll of the UAV 10 in flight. In some embodiments, the propellers 14a, 14b can be tilted during takeoff and/or landing.

FIGS. 2B and 2C illustrate cross-sectional views of the UAV 10 along the cut-planes 2B-2B and 2C-2C of FIG. 1F, respectively. As illustrated in FIG. 2B, the front leg 36 can be coupled to (e.g., mounted to) a first leg motor 40 or other actuator. The first leg motor 40 can be positioned partially or entirely within the main body 12 of the UAV 10. The first leg motor 40 can be configured to rotate the front leg 36 between the extended and retracted positions described above. In some embodiments, the first leg motor 40 is a servo motor, step motor, brushless motor, and/or some other electric motor configured to rotate the front leg 36. Turning to FIG. 2C, the rear leg 38 can be mounted to a second leg motor 42. The second leg motor 42 can be the same as or similar to the first leg motor 40 coupled to the front leg 36. The second leg motor 42 can be configured to rotate the rear leg 38 between the extended and retracted positions described above. In some embodiments, the first and second leg motors 40, 42 are mounted on opposite sides of a plane that bisects the main body 12 and passes through the upper and lower surfaces of the main body 12. Positioning the first and second leg motors 40, 42 on opposite sides of this plane can help to balance the UAV 10 by reducing net weight differentials between the two lateral halves of the main body 12.

In some embodiments, the first and second leg motors 40, 42 are positioned at or near the center of gravity of the UAV 10, both when the legs are extended and when the legs 36, 38 are retracted. In some embodiments, the center of gravity of the UAV 10 is between the first and second leg motors 40, 42 in a direction parallel to the length L1 (FIG. 1D) of the stabilizers 24a, 24b. Positioning the first and second leg motors 40, 42, and thereby the attachment points of the front and rear legs 36, 38, surrounding or near the center of gravity can improve stability of the UAV 10 when it is on the ground.

FIG. 2D illustrates a perspective view of the UAV 10 with the lower and upper surfaces of the main body 12 removed. In some embodiments, the UAV 10 includes one or more spars connected to the stabilizers 24a, 24b. For example, the UAV 10 can include a first spar 44a connected to the stabilizers 24a, 24b at or near the front portion 16 of the main body 12. The UAV 10 can include a second spar 44b connected to the stabilizers 24a, 24b between the first spar 44a the rear portion main body 12.

The UAV 10 can include one or more ribs extending from the front portion 16 to the rear portion 22 of the main body 12. In the illustrated embodiment, the UAV 10 includes two ribs 46a, 46b. The spars 44a, 44b can pass through or otherwise be connected to the ribs. 46a, 46b. One or both of the ribs 46a, 46b can include movable portions 48a, 48b at a rear portion of the ribs 46a, 46b. The movable portions 48a, 48b of the ribs 46a, 46b can be configured to move the elevons 20a, 20b upward and downward in response to actuation by a motor or other mechanism. For example, a first elevon motor 50a can be coupled to one of the ribs 46a. The first elevon motor 50a can be configured to actuate the movable portion 48a of the rib 46a to move the first elevon 20a upward and downward. In some embodiments, the first elevon motor 50a is configured to rotate an actuator arm 52a connected to the motor 50a. The actuator arm 52a can be coupled to the movable portion 48a of the rib 46a via a linkage 54a. The linkage 54a can be, for example, a rod or other structure configured to translate movement of the actuator arm 52a to movement of the movable portion 48a of the rib 46a (and thereby, movement of the elevon 20a). In some embodiments, the UAV 10 includes one or more elevon rods 55 about which the movable portions 48a, 48b of the rib 46a, 46b rotate when actuated by the linkages 54a, 54b. The elevon rods 55 can be connected to the stabilizers 24a, 24b. The UAV 10 can include a second elevon motor 50b mounted to the other rib 46b and configured to operate in a same or similar manner as that described with respect to the first elevon motor 50a to control the second elevon 20b.

Other electrical and mechanical components within the main body 12 are also illustrated in FIG. 2D. For example, the UAV 10 can include one or more battery cells 56a, 56b configured to power the various components of the UAV 10. In some embodiments, the UAV 10 includes one battery cell 56a on one lateral side and a second battery cell 56b on the opposite lateral side. Evenly positioning the battery cells on opposite sides of the UAV 10 can help to balance the UAV 10 and can also reduce interference with the front and rear legs 36, 38. The battery cells 56a, 56b can be connected to the motors and other components of the UAV 10 via one or more electrical wires (not shown). The battery cells 56a, 56b can also be connected to the solar panels 26 in order to receive electrical charge from the solar panels 26.

The UAV 10 can include propeller motors 60a, 60b configured to actuate the propellers 14a, 14b to provide thrust to the UAV 10. Each of the propellers 14a, 14b can include a motor mounted immediately adjacent the propeller blades. In some embodiments, the propellers 14a, 14b and propeller motors 60a, 60b are mounted to the respective ribs 46a, 46b of the UAV 10. The propeller motors 60a, 60b can be configured to operate independently of each other to allow for differential thrust between the propellers 14a, 14b.

In some embodiments, the UAV 10 includes one or more imaging devices (e.g., cameras 62) and positioned at least partially within the main body 12 of the UAV 10. In some embodiments, the camera 62 is configured to rotate about the pitch, yaw, and or roll axes of the UAV 10 with respect to the main body 12. The camera 62 can be positioned at or near the center of mass of the main body 12. In some embodiments, the main body 12 includes a transparent portion or an aperture on a lower portion of the main body 12. The transparent portion/aperture can provide the camera 62 with a field-of-view below the UAV 10.

The UAV 10 can include one or more controllers 64 configured to control operation of the motors, propellers 14a, 14b, elevons 20a, 20b, cameras 62, and/or other components of the UAV 10. The controller 64 can be connected to the various components of the UAV 10 via wired and/or wireless connections. In some embodiments, additional electronics 66 (circuit boards, power distribution boards, etc.) can be positioned within the main body 12 of the UAV 10.

In some embodiments, the UAV 10 (e.g., the main body 12 of the UAV 10) is constructed from a foam material or other lightweight material. In some such embodiments, the above-described battery cells, motors, cameras, electronics, and/or controllers are positioned within pockets formed in the lightweight material. Additionally, in some such embodiments, the UAV 10 is constructed without spars or ribs. For example, the elevons 20a, 20b can be formed by thinning a portion of the main body 12 of the lightweight material to form living hinges. The elevon portions of the lightweight material can be configured to rotate upward and downward about the living hinges in response to actuation by the actuator arms described above. Constructing all or a portion of the main body 12 of the UAV 10 from foam or other lightweight material can reduce manufacturing costs and/or complexity. Such construction can also reduce the weight of the UAV 10. For example, the UAV 10 can weigh between 0.5-5 pounds, between 1-7 pounds, between 0.75-1.5 pounds, and/or between 0.9-2 pounds. In some embodiments, the UAV 10 weighs approximately 1 pound.

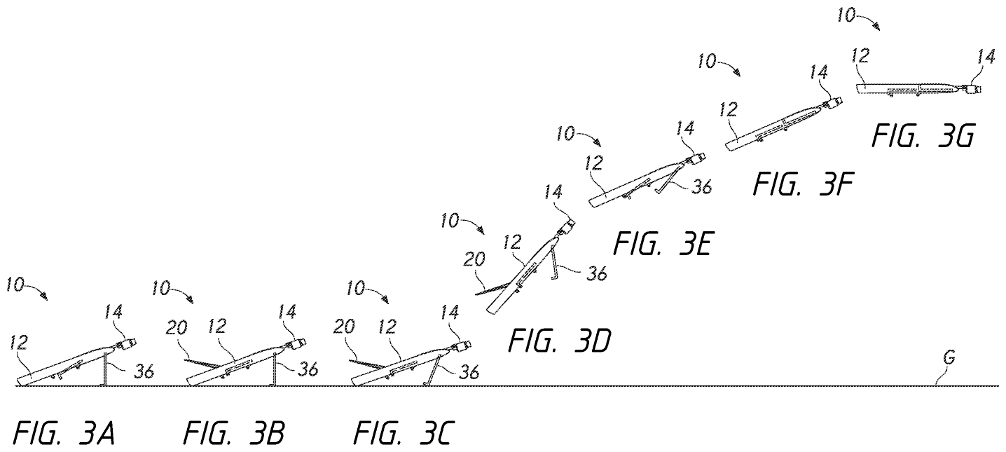

FIGS. 3A-3G illustrate a takeoff or launch procedure for the UAV 10, carried out in accordance with embodiments of the present technology. In a landed position (FIG. 3A), the front leg 36 can elevate the front portion of the main body 12 to position the propellers 14 away from the ground. The position of the front leg 36 can be adjusted to adjust the initial trajectory angle of the UAV 10 as it takes off. For example, in the presence of high headwinds it may be advantageous to lower the trajectory angle of the front end of the UAV 10. When taking off with high tailwinds, it may be advantageous to increase the trajectory angle of the front end of the UAV 10. The elevons 20 can be rotated to a raised position (FIG. 3B) to help provide initial upward lift when the propellers 14 are powered.

During initial takeoff (FIG. 3C) the propellers 14 can be powered to provide thrust to the UAV 10. In some embodiments, the front leg 36 is rotated toward the stowed position to provide additional forward and/or upward thrust to the UAV. In some embodiments, the front leg 36 can be telescoping and can be extended rapidly in order to provide upward thrust in addition to the thrust provided by the propellers 14. In some embodiments, the front and/or rear legs 36, 38 can be spring-loaded and configured to rapidly rotate to provide initial upward thrust. As the propellers 14 approach full thrust, the UAV 10 can begin to lift off the ground G (FIG. 3D). As the UAV 10 lifts off the ground, the elevons can return to a level position and the front leg 36 can begin to retract into the main body 12 of the UAV 10 (FIG. 3E) until the front leg 36 is fully stowed (FIG. 3F). In some embodiments, the UAV 10 can be oriented vertically (e.g., wherein the propellers 14 are oriented away from the ground G) at some point during takeoff. The elevons 20 can be tilted downward to lift the rear portion of the UAV 10 until the UAV 10 attains a desired flight trajectory (FIG. 3G).

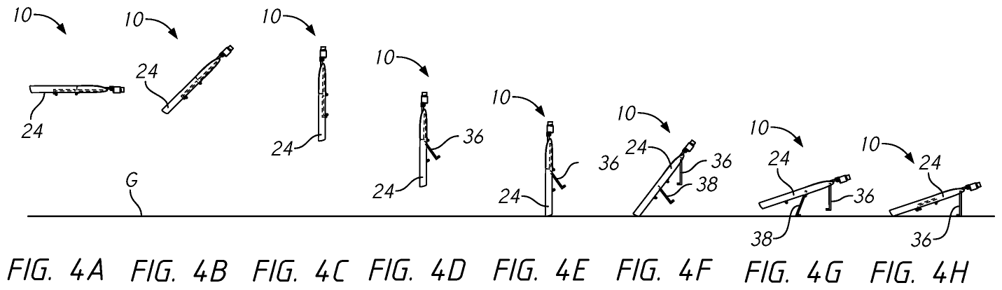

FIGS. 4A-4H illustrate a procedure for landing procedure for the UAV 10 in accordance with embodiments of the present technology. In some embodiments, as the UAV 10 transitions from a level flight orientation (FIG. 4A) toward landing, the elevons can be oriented upward and/or the propeller thrust can be reduced to cause the UAV 10 to pitch upward (FIG. 4B). The UAV 10 can continue to pitch upward until UAV 10 is oriented vertically (FIG. 4C). Propeller thrust can be reduced to allow the UAV 10 to approach the ground. In some embodiments, the rear leg 38 transitions from the stored position to an extended position as the UAV 10 approach is a ground (FIG. 4D). Extending the legs 36, 38 can shift the center of gravity of the UAV 10 away from the upper surface of the UAV 10. Eventually, the UAV 10 (e.g. the stabilizers 24) contacts the ground G while in a vertical or generally vertical orientation (FIG. 4E). The momentum of the UAV 10 and/or the weight of the legs can cause the UAV 10 to tilt toward the ground G. Thrust from the propellers 14 can slow the tilting of the UAV 10 while the front leg 36 transitions from the stowed position to the extended position (FIG. 4F). In some embodiments, the rear leg 38 contacts the ground before the front leg 36. Thrust from the propellers 14 and/or momentum of the UAV 10 can cause the rear portion of the UAV 10 to lift off the ground G (FIG. 4G) until the front leg 36 contacts the ground. The rear leg 38 can be retracted into the main body of the UAV 10, thereby causing the rear portion of the UAV 10 (e.g. the stabilizers 24) to contact the ground. In the fully landed position (FIG. 4H), the stabilizers 24a, 24b and the front leg 36 can form three points of contact (e.g., a tripod) with the ground. The three points of contact can reduce the risk of the UAV 10 inadvertently falling over while on the ground.

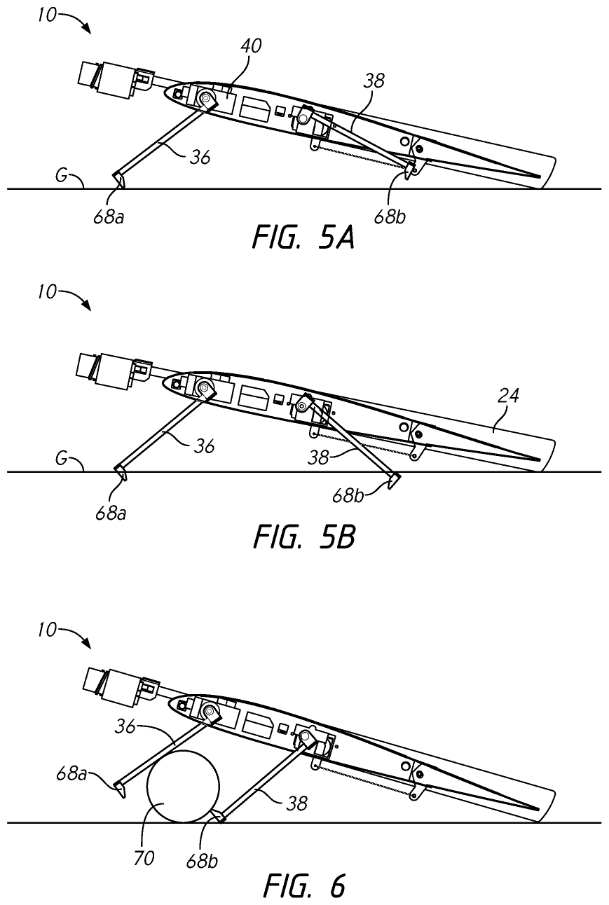

In some scenarios (e.g. high winds), it may be necessary or desired to secure the UAV 10 to a landing site. For example, it may be desirable to secure the UAV 10 to the ground G to reduce the risk of the UAV 10 falling over or otherwise being damaged by high winds. FIGS. 5A and 5B illustrate a method of securing the UAV 10 to the ground, in accordance with embodiments of the present technology. As illustrated in FIG. 5A, the rear leg 38 can be transitioned from the retracted position toward the extended position when the UAV 10 is landed on the ground. One or both of the front leg 36 and the rear leg 38 can include an attachment feature 68a, 68b (e.g., a hook feature, a claw feature, or some other suitable attachment feature) at the free end of leg. As the rear leg 38 continues to transition toward the extended position, the rear leg 38 will contact the ground. The second leg motor 42 (FIG. 2D) can be configured to continue to apply torque to the rear leg 38 to cause the attachment feature 68b to dig in the ground or other landing site. In some embodiments, the front leg motor 40 can be configured to apply torque to the front leg 36, causing the attachment feature 68a of the front leg 36 to also dig into the ground. In this manner, the UAV 10 can “grasp” the ground to secure the UAV 10 and reduce the risk that the UAV 10 falls over or leaves the ground during high winds.

In some instances, the landing site is not the ground. For example, the landing site can be a fence, tree branch, railing, or other landing structure 70, as illustrated in FIG. 6. In some such scenarios, the first and second legs 36, 38 can be used to grasp or otherwise releasably secure the UAV 10 to the landing structure 70. In some embodiments, the attachment features 68a, 68b can dig into the landing structure 70. In some embodiments, the attachment features 68a, 68b can reach around (e.g., hug or grasp) the landing structure 70 in order to inhibit or prevent accidentally detaching the UAV 10 from the landing structure 70.

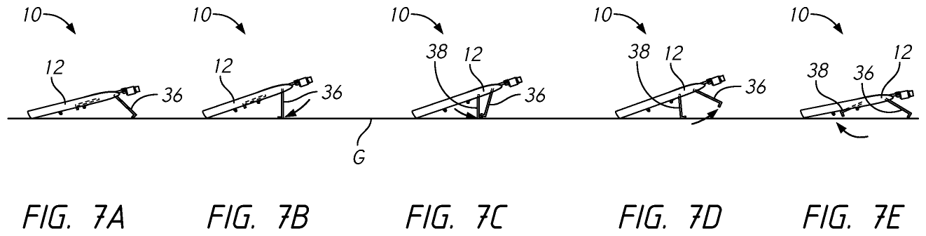

In some embodiments, UAV 10 is configured to walk, crawl, or otherwise traverse the ground. FIGS. 7A-7E illustrate a method used by the UAV 10 to walk across the ground G. From an initial landed configuration (FIG. 7A), the front leg 36 can retract toward the main body 12 (FIG. 7B). Rotating the front leg 36 toward the stowed position can drag the main body 12 of the UAV 10 forward. As the main body 12 is dragged, the stabilizers 24a, 24b can act as skis to reduce friction between the UAV 10 and the ground G, and to reduce the risk of damaging the main body 12 as the UAV 10 moves. The rear leg 38 can then rotate away from the stowed position to contact the ground G (FIG. 7C). After the rear leg 38 is rotated away from the stowed position, the front leg 36 can rotate away from the stowed position and toward its original position in the initial landed configuration (FIG. 7D). The rear leg 38 can rotate toward the stowed position, which would further drag the main body 12 of the UAV 10 forward. The rear leg 38 can continue to rotate toward the stowed position until the front leg 36 contacts the ground G and the UAV 10 is returned to the initial landed configuration (FIG. 7E). These steps can be repeated as many times as necessary to traverse a desired distance along the ground. In some embodiments, differential thrust is applied to the propellers 14a, 14b to turn the UAV 10 while walking. For example, increasing power to the left propeller compared to the right propeller can cause the UAV 10 to turn to the right. Conversely, increasing power to the right propeller compared to the left propeller can cause the UAV 10 to turn to the left.

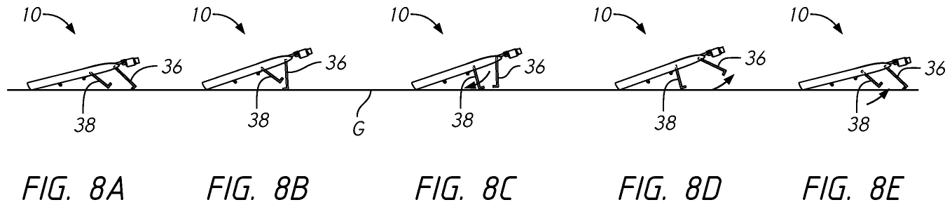

FIGS. 8A-8E illustrates another method used by the UAV 10 to walk across the ground. In this method, both the front and rear legs 36, 38 can be in deployed positions when the UAV 10 is in an initial landed configuration (FIG. 8A). In order to drag the main body 12 forward, the front leg 36 can be rotated toward the stowed position (FIG. 8B). As the front leg 36 is rotated toward the stowed position the rear leg 38 can be rotated toward its stowed position to further drag the main body 12 forward (FIG. 8C). As the rear leg 38 is rotated toward its stowed position, the front leg 36 can be rotated toward its deployed position (FIG. 8D). The rear leg 36 can then quickly rotate toward its maximum deployed position, causing the front leg 36 to contact the ground G (FIG. 8E), thereby returning the UAV 10 to its initial landed configuration.

The walking methods described above with respect to FIGS. 7 and 8 can be performed over flat terrain or uneven terrain. For example, because the UAV 10 only contacts the terrain using the legs and stabilizers 24a, 24b (e.g., instead of tracks or wheels), the UAV 10 does not require the terrain be flat in order to use the legs 36, 38 to drag the UAV 10 across the terrain. Additionally, because the propellers 14a, 14b can turn the UAV 10 without contacting the ground, the UAV 10 can easily turn to avoid obstacles such as boulders, trees, or other structures that would otherwise prevent walking. In some embodiments, one or both of the front and rear legs 36, 38 can rotate up to 360°. Using legs with large angles of rotation can allow the UAV to “step over” larger obstacles.

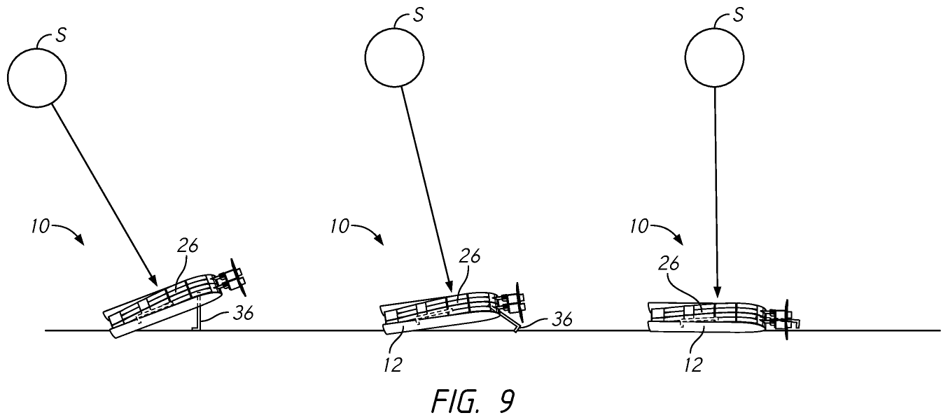

FIG. 9 illustrates a method of orienting the UAV when on the ground, in accordance with embodiments of the present technology. Specifically, when landed, the UAV 10 can be reoriented as desired or needed to optimize the charging rate of the solar charging panels 26. For example, the UAV 10 can be reoriented to bring the solar charging panels 26 closer to a perpendicular orientation with respect to the sun S. In some instances, the UAV 10 may be tilted upward away from the ground when the sun S is lower in the horizon. As the sun S passes through the sky, the UAV 10 (e.g. the front portion of the UAV 10) may be lowered or raised by rotating the front and/or back legs to follow the sun's passing. In some embodiments, the propellers 14a, 14b can be used to rotate the UAV 10 using differential thrust as described above with respect to FIGS. 7 and 8, in order to bring the UAV 10 into further alignment with the sun S. In some embodiments, the UAV 10 can be configured to rotate in flight (e.g., by modifying the thrust produced by one or both of the propellers 14a, 14b and/or by moving the elevons 20a, 20b) in order to land in an initial landing position and orientation selected (e.g., optimized) to align with the sun S.

In some embodiments, the UAV 10 is configured to actively detect the position of the sun S with respect to the UAV 10. Such detection can be performed by monitoring the charge rate of the solar panels 26 as the UAV 10 is reoriented. For example, if increased charging is detected as the UAV 10 is oriented in a specific direction, the UAV 10 can confirm that this direction of reorientation is bringing the UAV 10 into closer alignment with the sun S. Conversely, if the UAV 10 detects that the charge rate decreases as the UAV 10 is oriented in a specific direction, the UAV 10 can confirm that this direction of reorientation is moving the UAV 10 out of alignment with the sun S.

In some embodiments, the UAV 10 (e.g., the controller) can be programmed to know the position of the sun-based on the time of day and the UAV's geographic position. The time and geographic information can be utilized to determine the relative position of the sun compared to the UAV 10 position. The UAV 10 may then automatically reorient to align with the sun when landed.

The UAVs 10 described herein can be used for long-range, rural, and/or infrastructure-free missions. For example, given the efficient charging facilitated by the large solar panels 26, the UAVs 10 can have an extensive flight range without landing. In some embodiments, the UAVs 10 can fly between 3-20 hours, between 5-22 hours, between 6-18 hours, between 8-24 hours, and/or between 10-15 hours per day. Also, because the UAVs 10 do not require fixed charging or refueling stations, the UAVs 10 can be used to execute missions in inhospitable territory. The UAVs 10 can be configured to detect danger (e.g., fire, human activity, etc.) using the camera 62 and/or other sensors (e.g., motion sensors, infrared sensors, temperature sensors, light sensors, etc.). The UAVs 10 can be configured to take off and land at an alternate location upon detection of danger at an initial landing position. Additionally, the UAVs' above-described ability to attach to the ground or other landing structures can allow the UAVs 10 of the present disclosure to operate in geographically diverse environments under weather conditions in which other UAVs 10 would sustain damage.

FIG. 10 illustrates an example of a network of UAVs 10 configured in accordance with embodiments of the present technology. As illustrated, multiple UAVs 10 may be used to establish a surveillance or monitoring perimeter (e.g., a mission perimeter 80) about one or more mobile or otherwise dynamic bases 82. These bases 82 can be, for example, one or more vehicles, robotic apparatuses, temporary bases of operation, or other non-fixed hubs. The radius of the mission perimeter 80 can be adjusted based on operating conditions. For example, the radius of the mission perimeter 80 can be approximately equal to half of the UAVs' range without landing. In some embodiments, the radius of a mission perimeter 80 can be extended to account for landing and charging of the UAVs 10 during the mission. Because the UAVs 10 include large and efficient solar panels, there is little or no need for the dynamic base 82 to include separate charging or refueling capabilities. The dynamic base 82 can be moved in response to weather conditions, sunlight, security considerations, and/or other predetermined or evolving considerations. In some missions, the dynamic base 82 is no more than a location used to define the radius of the mission perimeter.

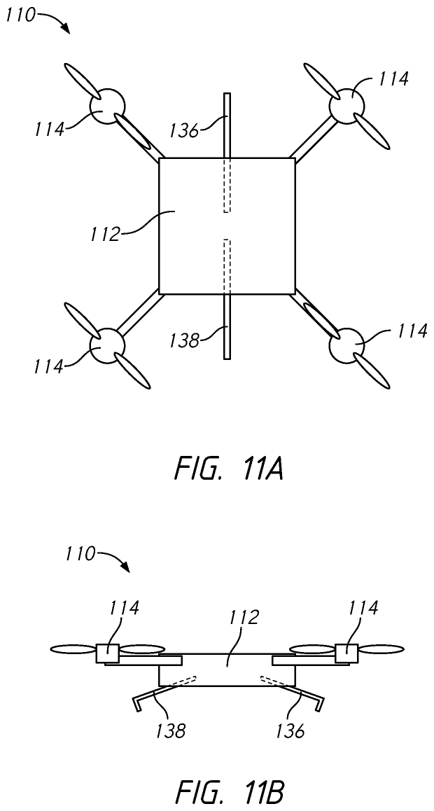

FIGS. 11A and 11B illustrate a top plan view and a side elevational view, respectively of another UAV 110 configured in accordance with embodiments of the present technology. The UAV 110 can include two or more propellers 114 configured to lift the UAV 110 from the ground and orient the UAV 110 in flight. In some embodiments, the UAV 110 has a quad copter design. The UAV 110 can include first and second legs 136, 138 configured to rotate between extended positions (FIG. 11B) in which the legs 136, 138 extend downward and radially outward from a main body 112 of the UAV 110, and retracted positions in which the legs 136, 138 are positioned partially or fully within the main body 112. The UAV 110 can include one or more motors (not shown) configured to operate the legs 136, 138. The motors of the UAV 110 can be the same as or similar to the leg motors 40, 42 described above. The legs 136, 138 can be configured to grasp the ground or other landing structure in a manner similar to or the same as that described above with respect to FIGS. 5A-6.

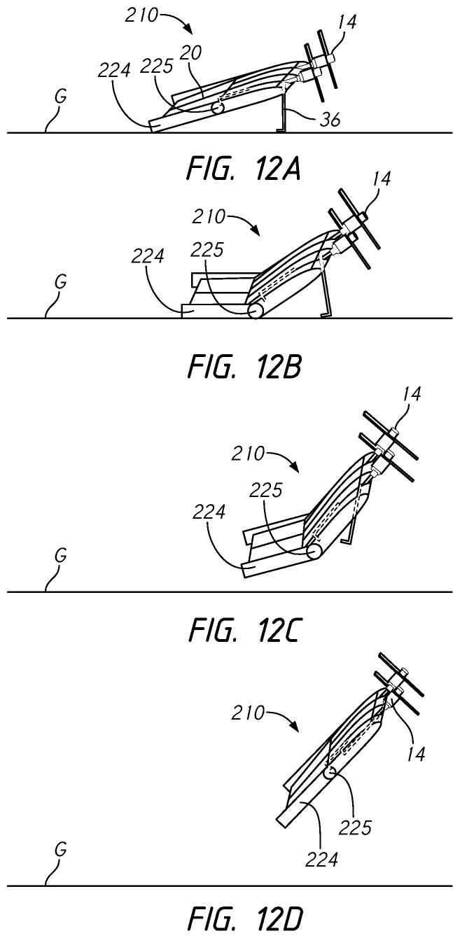

FIGS. 12A through 12D illustrate another UAV 210 configured in accordance with the embodiments of the present technology. Except as described below, the UAV 210 of FIGS. 12A-12D can have generally the same structure and function as the UAV 10 described above. The UAV 210 can include stabilizers 224 having one or more hinges 225 or other bending points. In some embodiments, the hinges 225 of the stabilizers 224 are coincident with the hinges about which the elevons 20 rotate. As illustrated in FIG. 12B, the stabilizers 224 (e.g. rear portions thereof) can bent upward to tilt the propellers 14 upward and away from the ground G. Tilting the propellers 14 upward can allow for quicker (e.g., more direct) upward acceleration of the UAV 210 from the ground during takeoff (FIG. 12C). Once the UAV 210 has cleared the ground G, the stabilizers 224 can rotate back to a straightened configuration for horizontal flight.

In some embodiments, in addition to or instead of bending the stabilizers 224, the propellers 14 can be configured to pivot upward with respect to the main body 12, as illustrated and explained above with respect to FIG. 2A. Pivoting the propellers 14 upwardly can increase the upward thrust provided by the propellers 14 during initial takeoff. The propellers 14 can return to their original or aligned position after initial takeoff. In some embodiments, the propellers 14 can be tilted independently of each other to control roll of the UAV 10, 210 during flight.

From the foregoing, it will be appreciated that specific embodiments of the present technology have been described herein for purposes of illustration, but that various modifications that may be made without deviating from the technology. For example, the UAV 10 may include only a front leg 36 and not a rear leg 38. In some such embodiments, a rear portion of the stabilizers 24a, 24b or some other component of the UAV 10 includes an attachment feature configured to, along with the attachment feature the front leg 36, grasp the ground or other landing site to secure the UAV to the ground. In some embodiments, the UAV includes more than one rear leg and/or more than one front leg, wherein the rear legs and front legs are spaced apart laterally. In some such embodiments, the movement of the rear and front legs on one lateral side can turn the UAV toward the opposite lateral side while walking on the ground.

Certain aspects of the technology described in the context of particular embodiments may be combined or eliminated in other embodiments. Further, while advantages associated with some embodiments of the present technology have been described in the context of those embodiments, other embodiments may also exhibit such advantages, and not all embodiments need necessarily exhibit such advantages to fall within the scope of the present technology. Accordingly, the present disclosure and associated technology can encompass other embodiments not expressly shown or described herein.

As used herein, the term “and/or” as in “A and/or B” refers to A alone, B alone and both A and B. The term “approximately” and “generally” refer to values or characteristics within ±10% of the stated value or characteristic, unless otherwise stated. To the extent any materials incorporated herein by reference conflict with the present disclosure, the present disclosure controls.

1. An unmanned aerial vehicle (UAV) comprising:
a wing having—
a front portion;
a rear portion opposite the front portion;
a first lateral portion extending from the front portion to the rear portion;
a second lateral portion opposite the first lateral portion and extending from the front portion to the rear portion;
an upper surface extending from the front portion to the rear portion and from the first lateral portion to the second lateral portion; and
a lower surface opposite the upper surface and extending from the front portion to the rear portion and from the first lateral portion to the second lateral portion;
a first propeller extending from the front portion away from the rear portion, the first propeller having a first axis of rotation and positioned to provide thrust to the UAV in a direction parallel to the first axis of rotation;
a second propeller extending from the front portion away from the rear portion and positioned between the first propeller and the second lateral portion of the wing, the second propeller having a second axis of rotation and positioned to provide thrust to the UAV in a direction parallel to the second axis of rotation;
a first actuator carried by the wing; and
a first leg operably coupled to the first actuator and configured to rotate in a first plane parallel to a plane bisecting the wing through the front portion and the upper surface.

2. The UAV of claim 1, further comprising:
a second actuator carried by the wing; and
a second leg operably coupled to the second actuator and configured to rotate in a second plane parallel to the first plane

3. The UAV of claim 1 wherein the first leg comprises a hook feature on an end of the first leg opposite the first actuator.

4. The UAV of claim 1 wherein the first actuator is configured to rotate the first leg between a retracted position and a deployed position, wherein the first leg is positioned entirely within the wing in the stowed position, and wherein the first leg extends from the wing in a direction opposite the rear portion and opposite the upper surface in the deployed position.

5. The UAV of claim 1 wherein the first actuator is positioned within the wing.

6. The UAV of claim 2 wherein:
the first plane is coplanar with the second plane;
the first actuator is positioned between the second actuator and the front portion of the wing;
the second actuator is configured to rotate the second leg between a stowed position and a deployed position;
the second leg is positioned entirely within the wing in the stowed position; and
the second leg extends from the wing in a direction opposite the front portion and opposite the upper surface in the deployed position.

7. The UAV of claim 1, further comprising:
a first stabilizer connected to the first lateral portion of the wing, the first stabilizer extending above the upper surface and below the lower surface at the rear portion of the wing; and
a second stabilizer connected to the second lateral portion of the wing, the second stabilizer extending above the upper surface and below the lower surface at the rear portion of the wing.

8. The UAV of claim 7 wherein the first stabilizer extends from the front portion to the rear portion of the wing, and wherein the second stabilizer extends from the front portion to the rear portion of the wing.

9. The UAV of claim 7 wherein the first stabilizer has a shape that matches a profile of the wing from the front portion to a position 20% toward the rear portion when observed in a direction normal to a plane that bisects the wing between the first lateral portion and the second lateral portion.

10. The UAV of claim 2 wherein the first is configured to grasp the ground when the UAV is landed.

11. The UAV of claim 1, further comprising one or more battery cells within the wing and one or more solar panels on the upper surface of the wing configured to charge the one or more battery cells.

12. The UAV of claim 11 wherein the one or more solar panels cover at least 75% of the upper surface of the wing.

13. The UAV of claim 11 wherein the one or more solar panels cover at least 90% of the upper surface of the wing.

14. The UAV of claim 11 wherein the first leg and/or the second leg are configured to tilt the wing to change an angle between the sun and the solar panels when the UAV is landed.

15. The UAV of claim 1 wherein the wing comprises a first elevon and a second elevon at the rear portion of the wing.

16. The UAV of claim 15 wherein the first and second elevons span the entire rear portion.

17. The UAV of claim 15 wherein the first elevon spans a first half of the rear portion and the second elevon spans a remaining half of the rear portion.

18. The UAV of claim 15, further comprising a solar panel carried by the first elevon.

19. The UAV of claim 1 wherein the first leg and/or the second leg are telescoping.

20.-33. (canceled)

34. An unmanned aerial vehicle (UAV) comprising:
a wing having—
an upper surface; and
a lower surface opposite the upper surface;
a first propeller extending forward from a front portion of the wing and positioned to provide thrust to the UAV;
a second propeller extending forward from the front portion of the wing and positioned to provide thrust to the UAV;
a first actuator connected to the wing;
a first leg operably connected to the first actuator and configured to rotate in a first plane parallel to a plane bisecting the wing through the front portion and the upper surface; and
one or more solar panels carried by the wing and covering at least 75% the upper surface of the wing.

35. The UAV of claim 34 wherein the one or more solar panels cover at least 90% of the upper surface of the wing.

36. The UAV of claim 34, further comprising:
a first stabilizer positioned at a first side of the wing, the first stabilizer extending above the upper surface and below the lower surface at a rear portion of the wing; and
a second stabilizer positioned at a second side of the wing, the second stabilizer extending above the upper surface and below the lower surface at the rear portion of the wing.

37. The UAV of claim 36 wherein the first stabilizer comprises a first portion and a second portion connected to the first portion at a first hinge, and wherein the first portion is configured to articulate in a direction away from the lower surface of the wing before the UAV takes off from the ground.

38. The UAV of claim 37 wherein the second stabilizer comprises a first portion and a second portion connected to the first portion at a second hinge, and wherein the first portion is configured to articulate in a direction away from the lower surface of the wing before the UAV takes off from the ground.

39. The UAV of claim 38 wherein the wing comprises a first elevon and a second elevon at the rear portion of the wing.

40. The UAV of claim 39 wherein the first elevon is configured to articulate parallel to the first portion of the first stabilizer before the UAV takes off from the ground, and wherein the second elevon is configured to articulate parallel to the first portion of the second stabilizer before the UAV takes off from the ground.

41. The UAV of claim 34 wherein the first propeller is configured to tilt in a direction parallel to a plane that bisects the wing through the upper and lower surfaces.

42. The UAV of claim 46 wherein the second propeller is configured to tilt in a direction parallel to the plane that bisects the wing through the upper and lower surfaces.
